(19) United States
(12) Patent Application Publication
(10) Pub. No.: US 2014/0238189 A1
(43) Pub. Date: Aug. 28, 2014

(54) DRIVE FOR A VERTICAL MILL WITH A PLURALITY OF MAIN DRIVES

(71) Applicant: Marino Matosevic, Meudon (FR)

(72) Inventor: Marino Matosevic, Meudon (FR)

(73) Assignee: COMPAGNIE ENGRENAGES ET REDUCTEURS - MESSIAN - DURAND, Cambrai (FR)

(21) Appl. No.: 14/343,260

(22) PCT Filed: Sep. 7, 2012
(86) PCT No.: PCT/EP2012/067521

§ 371 Date: Apr. 30, 2014

(30) Foreign Application Priority Data
Sep. 9, 2011 (FR) 1158040

(51) Int. Cl. F16H 1/22

(52) U.S. Cl. CPC F16H 1/22
USPC 74/665 A

(57) ABSTRACT

The drive device according to the invention for a vertical roller mill comprises an output gear wheel fixed or capable of being fixed to a rotating grinding table of the vertical roller mill; and a plurality of main drives; a support structure having a ceiling plate; each main drive having a motor and a main gear unit comprising a drive gear capable of meshing with the output gear wheel; said output gear wheel being driven by each of said main drives, wherein said main drives are fitted below the ceiling plate and at least the main gear unit is partially suspended from the ceiling plate, in particular the main drive is partially suspended from the ceiling plate.

The present invention generally relates to a drive device for a vertical roller mill, the drive device comprising
an output gear wheel fixed or capable of being fixed to a rotating grinding table of the vertical roller mill; and
a plurality of main drives;
a support structure having a ceiling plate;

each main drive having a motor and a main gear unit comprising a drive gear capable of meshing with the output gear wheel;

said output gear wheel being driven by each of said main drives.

The invention relates to gear drives for a vertical roller mill (VRM), and more particularly a group of main drives arranged vertically, fitted below the rotating table inside the drive support structure by VRM meshing.

Vertical roller mills (VRM) are used in the cement industry to grind clinker and coal, and to prepare raw materials. VRM drives, and in particular large or high-power drives, can present reliability problems related to the pair of conical input gear wheels, which is one of the most critical mechanical components of the VRM drive.

Today, the most used VRM drives are reducing gears using, at high speed or as input, pairs of conical gear wheels, and at low speed or as output, planetary stages or reducing gears, which combine the pairs of conical gear wheels—with helical and planetary gear sets, all having a relatively long kinematic chain that is flexible in torsion, which is by definition sensitive to the torque variations specific to the grinding method of the VRM.

In high-power VRM planetary reducing gears (>3,500 kW), satellites must in principle be mounted on smooth bearings due to physical limitations so that the bearings have a long enough lifetime.

The most recent generation of high-power VRM drives uses epicyclic or planetary low-speed gear stages with several satellites to allow the transmission of torque in a reduced space. Planetary stages with several satellites (>3) are sensitive to the distribution of power between the sun gear and the ring gear if they are not equipped with a fitting of the satellites on an elastic axle, as described in document U.S. Pat. No. 3,303,713.

Consequently, one aim of the present invention is to propose a drive device for a vertical roller mill that is easy to maintain and has improved statistical characteristics. Another aim of the invention is to propose a drive device that has a relatively rigid structure for given dimensions.

To that end, the invention proposes a drive device as indicated above, in which said main drives are fitted below the ceiling plate and at least the main gear unit is partially suspended from the ceiling plate, in particular the main drive is partially suspended from the ceiling plate.

The other features of the invention are:
the support structure comprises a base plate and outer columns, in which the ceiling plate, the base plate and the outer columns define an inner volume of the support structure, the inner volume having a size and shape in order to completely receive all of the main drives;
the support structure comprises a central column extending between the ceiling plate and the base plate, the central column preferably having a cylindrical shape, in particular having a circular transverse section;
each outer column has an arc-shaped transverse section, each of the arc-shaped transverse sections coinciding with a pitch circle;
at least one rib extends in the inner volume, in particular from each of the outer columns to the central column;
each main drive is a unit having a housing, as a result of which the unit is capable of being manipulated in a single piece independently of the other components of the drive device;
the housing is fastened to the ceiling plate, preferably exclusively fastened to the ceiling plate;
each main gear unit is a pseudo-planetary transmission with a stationary satellite carrier and a satellite with a double toothing or a planetary transmission;
the output gear wheel is a ring gear with an internal toothing or a ring gear with an external toothing or a gear wheel;
each drive gear is a spur gear, a helical gear or a self-aligning gear; and
each of said main drives is selectively removable from the output gear wheel and removable from the support structure without moving the support structure from its base.

The solution is in principle a VRM drive without a pair of conical input gear wheels, in which the vertically fitted coaxial main drives are arranged below the rotating table inside the VRM drive support structure. Said main drives are preferably identical. Each is made up of an electric motor with a permanent magnet, a transmission, preferably pseudo-planetary with a stationary satellite carrier and satellite with a double toothing or a planetary transmission, and a low-speed drive gear. Said low-speed drive gears share the load on the low-speed output gear wheel in equal parts. Said low-speed gear wheel is coupled to the rotating table of the VRM drive. The support structure of the VRM drive may withstand forces and flexion torques generated by the grinding process. The main drives may be replaced without removing the VRM drive from its base, where the described drive device may replace the originally installed reducing gear.

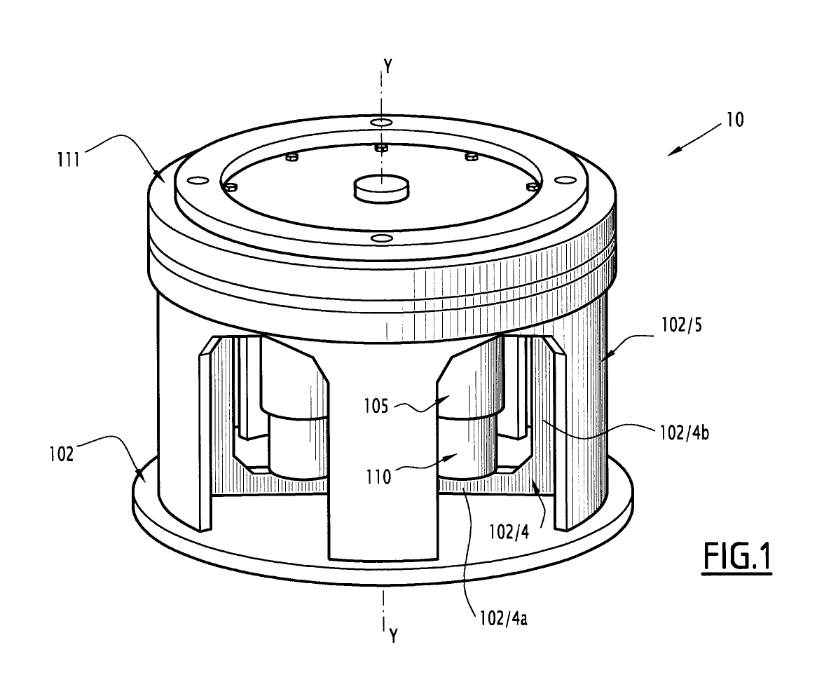

According to the present invention, the pairs of conical gear wheels may be avoided in the VRM transmissions by using a group or a plurality of coaxial main drives arranged vertically, fitted inside the transmission support structure, as shown in FIG. 1.

If a comparison is done with the VRM transmissions commonly used, the VRM drive described is less sensitive to the load variations caused by the grinding process due to a shorter and more rigid kinematic chain, in light of:
A low-speed output ring gear stage with several contacts between the ring gear and the gears and a relatively high gear ratio, which may transmit a high torque with a high torsional rigidity.
Each main gear unit is a coaxial transmission, preferably a planetary or pseudo-planetary transmission with a stationary satellite carrier and a satellite with a double toothing.

The power is distributed owing to the use of individual permanent magnet electric motors coupled to the main gear unit that transmit, independently of one another, the torque to the output gear wheel coupled with the rotating table of the VRM drive.

With respect to the present invention, the reliability and availability of the VRM drive are increased due to the specific group design, which in case of operating problems of a main gear unit, the mill may be completely stopped and the main drive may quickly be replaced with another main drive.

Each main gear unit with its associated motor may be removed from and fitted on the VRM drive without moving the support structure from its base, which still further increases the reliability and minimizes the downtime of the VRM.

The strategy for spare or replacement parts may be based on keeping a main drive, which is made up of a permanent magnet motor, a main gear unit with a drive gear and an associated housing, in inventory. The removed main drive is refurbished and kept in inventory, which increases the ease of upkeep at minimal costs.

Because the present invention adopts grouped main drives that are smaller in terms of size, it is ideal for less expensive serial production, which amounts to shorter timeframes due to greater availability, smaller forging, molded parts, rolling bearings or bearings, and motors. Consequently, each main drive may advantageously have satellite gear wheels that are mounted on rolling bearings. The present invention allows configurability, which means that a main drive of standard size and standard type may be used, in different numbers, for different VRM drive sizes. This configurability implies a high level of standardization, which is interesting for the gear manufacturer in order to reduce manufacturing costs and for the end user in order to reduce the costs of spare parts.

The present invention proposes a solution to remove and install the main drive switches easily; aside from being advantageous for easy upkeep, this is also advantageous for transport and lifting of the support structure with the rotating table and the output gear wheel. As mentioned in the claims, the drive device according to the present invention may be transported disassembled with main drives removed from the support structure, which may be advantageous for transport to sites with a relatively undeveloped infrastructure that are not very accessible with limited crane capacity. By disassembling the main drives, the gear and bearing contact adjustments for the VRM drive are not compromised.

The permanent magnet electric motor is a controlled main drive in terms of speed and torque, which provides the advantage of controlling a gentle start up and a variable and optimized grinding speed, and a precise torque distribution on each gear of the VRM drive.

The support structure considerably increases the rigidity of the drive device in all directions, owing to vertical inner radial walls or ribs advantageously placed between the main drives. This is very important for proper operation of the VRM.

The aspects of the invention described above will emerge more clearly with the attached drawings and more detailed description that follows, proposed solely as an example of the principles of the invention.

FIG. 1 shows a general perspective view of the drive device according to the present invention.

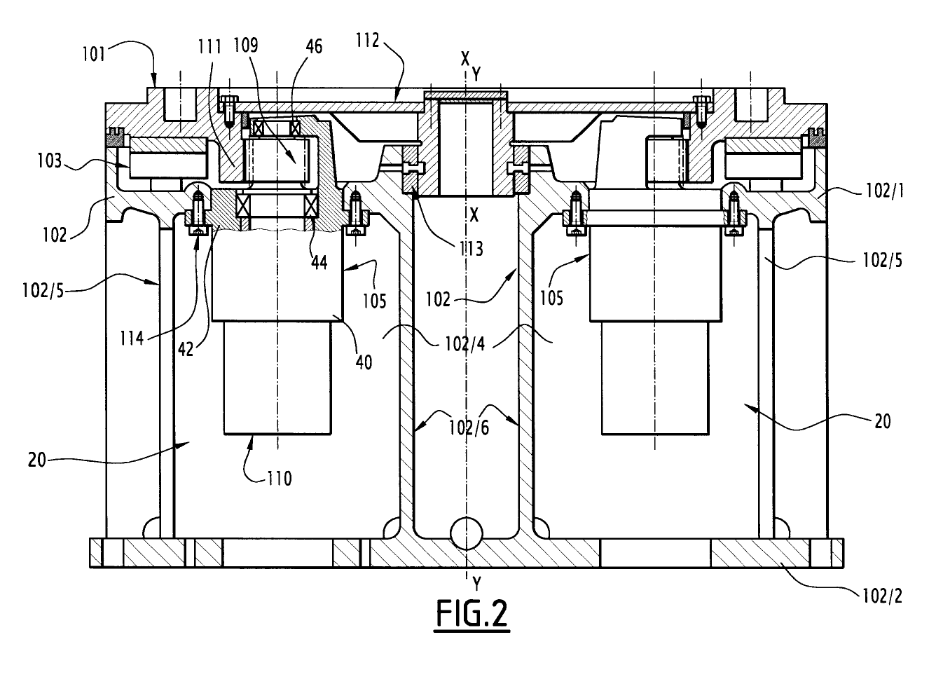

FIG. 2 shows the diagrammatic transverse section of the drive device according to the present invention with a low-speed gear stage arranged with an output ring gear with an internal toothing.

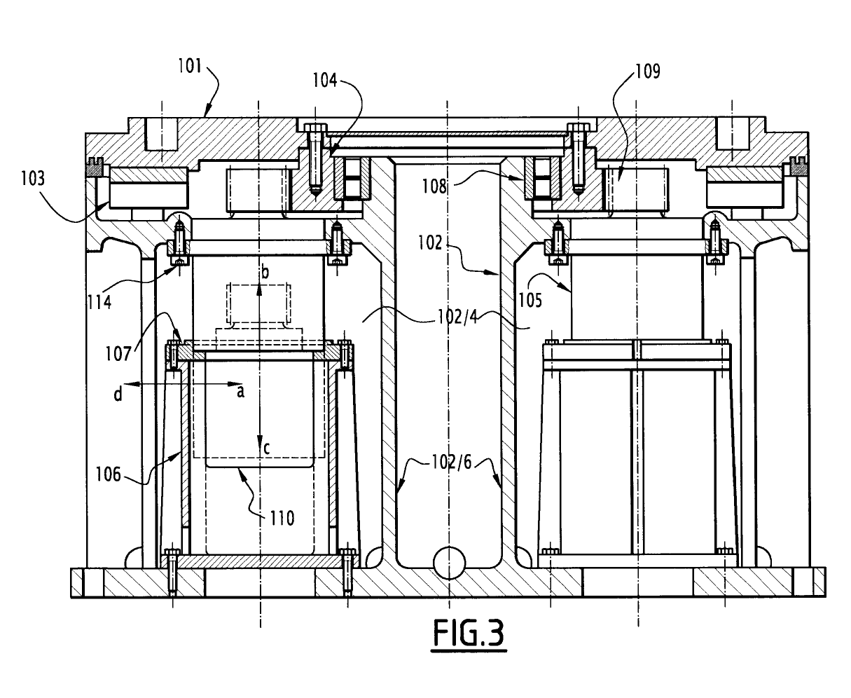

FIG. 3 shows the same drive device with a low-speed gear stage, arranged with an output ring gear with an external toothing.

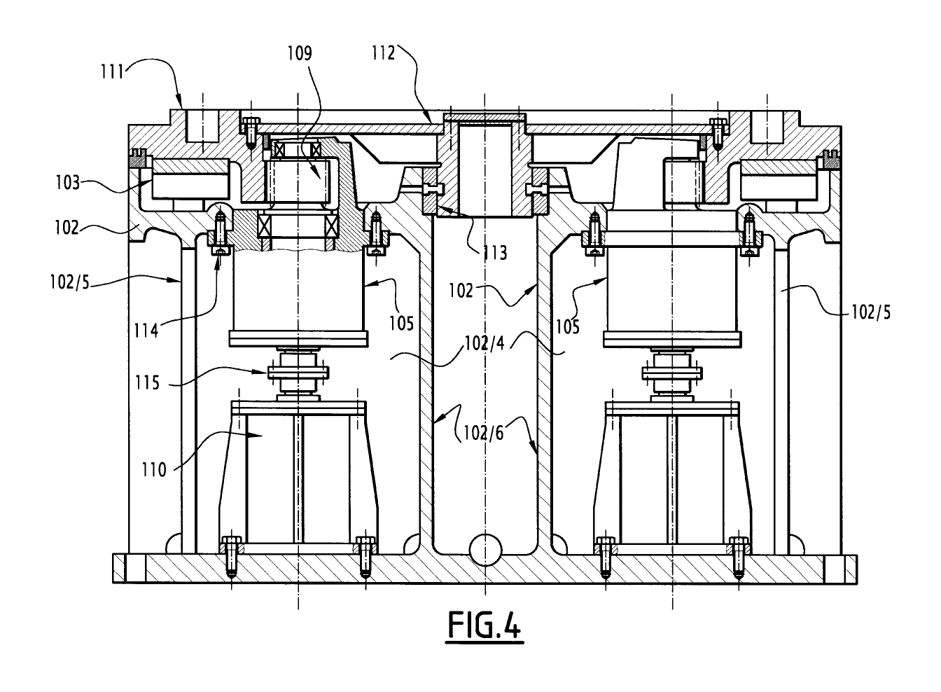

FIG. 4 shows the alternative of the drive device with a permanent magnet motor separated from the main gear unit.

FIG. 1 shows a drive device 10 according to the present invention.

The drive device 10 rotates a vertical roller mill (not shown) comprising a grinding table and grinding rollers that are capable of rolling on the grinding table so as to crush the material to be ground, such as clinker, coal or ore.

The drive device 10 comprises a drive device rotating table 101 capable of being fixed to the grinding table.

The drive device 10 is capable of driving the rotating table 101 of the drive device around an axis of rotation X-X.

The drive device 10 comprises an output ring gear 111 secured to the table 101 or capable of being fixed to the table 101 of the drive device.

The drive device 10 comprises a plurality of main drives 20, each capable of driving the output ring gear 111.

The drive device 10 defines a central axis Y-Y. This axis Y-Y coincides with the axis of rotation X-X.

Each main drive 20 comprises a motor 110 and a main gear unit 105 comprising a drive gear 109 meshing with the output ring gear 111.

The drive device 10 comprises a support structure 102 having a ceiling plate 102/1 and a base plate 102/2.

The main drives 20 are fitted below the ceiling plate 102/1 and completely suspended from the ceiling plate 102/1.

To that end, each main drive 20 is a unit having a housing 40 in which the motor 110 and main gear unit 105 are arranged. The housing 40 has a rim 42 with which the housing is fastened by screws 114 on the lower side of the ceiling plate 102/1.

The housing 40 is exclusively fixed on the ceiling plate 102/1, i.e., the housing is not fixed directly on another part of the support structure, such as the base plate 102/2. Thus, the housing 40 and the motor 110 are completely suspended from the ceiling plate 102/1.

When it is not fixed to the support structure 102, each main drive 20 is capable of being manipulated in a single piece independently of the other components of the drive device 10.

In FIG. 2, two main drive units 105 drive the output ring gear 111.

In the embodiment of FIG. 2, the output ring gear 111 is an integral part of the rotating table 101 of the drive device. In the embodiment shown in FIG. 3, the output ring gear 111 may be a separate part 104 from the rotating table 101 of the drive device and fixed, for example bolted, on the rotating table. Consequently, in FIG. 2, the output ring gear is a ring gear with an internal toothing. In FIG. 3, the output ring gear 111 is a ring gear with an external toothing. Alternatively, the output ring gear 111 may be an output gear wheel with an external toothing and having a solid central disc or web. The minimum number of main drives 20 is two, and the maximum is determined based on the dimensions of the installation, the transmitted power and the dimensions of the standard main drives. The vertical force, coming from the grinding process, actuates the rotating table 111 or 101 as far as the stop 103 and is then discharged or transferred into the foundations by the support structure 102.

The low-speed drive gear 109 may be made according to FIG. 3, in a cantilevered arrangement relative to the housing 40. Alternatively, the drive gear 109 is supported on the housing 40 with two bearings 44, 46 on each axial side of the gear 109, as shown in FIG. 2.

The drive gear 109 may be a spur or helical gear, as well as a self-aligning tilting gear. Both the output ring gear 111 with an internal toothing and the output ring gear with an external toothing or the output gear wheel can be driven by any of said gear design arrangements.

The main gear unit 105 is a coaxial transmission, preferably a pseudo-planetary transmission with a stationary satellite carrier with a double toothing.

The input toothing of this double toothing has a diameter larger than the diameter of the output toothing of said double toothing.

Alternatively, the coaxial transmission is a planetary transmission.

The motors are preferably permanent magnet electric motors 110, which have the advantage of good power concentration over volume that is appropriate for installation in tight spaces. The motors may preferably be cooled by fluid.

The support structure 102 further comprises outer columns 102/5 extending from the ceiling plate 102/1 to the base plate 102/2. The ceiling plate 102/1, the base plate 102/2 and the outer columns 102/5 define an inner volume of the support structure. The inner volume has a size and shape so as to completely receive all of the main drives 20.

The outer columns 102/5 are placed in an aligned manner below the stop 103 supporting the table 101 of the drive device.

The outer columns 102/5 have a curved transverse section, considered along a plane perpendicular to the axis Y-Y. Preferably, the transverse section is arc-shaped. In the present case, the transverse section of each of the outer columns coincides with a same pitch circle, in particular whereof the center coincides with the axis Y-Y.

Between each of the two adjacent outer columns 102/5, openings 50 are defined, which are of sufficient size to allow the main drives 20 to be installed and removed.

If necessary, the vertical stiffness may be increased with supports 106 for the main drives 20, shown as an example in FIG. 3.

The support structure 102 comprises a central column 102/6 extending between the ceiling plate 102/1 and the base plate 12/2. The central column 102/6 has a cylindrical shape with a circular transverse section. In the present case, the central column is a tube.

Advantageously, the central column 102/6 is the oil pan of the drive device.

Radial walls 102/4 arranged in the inner volume connect the central column 102/6 with each of the outer columns 102/5. Depending on the structural calculation of the support integrating the ceiling plate, the radial walls 102/4 may be solid or arranged with openings, as shown in FIG. 1.

If the radial wall 102/4 has an opening arranged in the central part of the wall, the radial wall forms a first rib 102/4a and a second rib 102/4b. The first rib 102/4a extends from the associated outer column 102/5 to the central column 102/6 and along the base plate 102/2 and connects the columns 102/5 and 102/6. The second rib 102/4b extends along the outer column 102/5 between the base plate and the ceiling plate and connects the plates 102/1 and 102/2.

The radial forces acting on the rotating table 111 may be retained via a centering web 112 by a radial bearing 113 that may be a smooth bearing, according to FIG. 2, or a rolling bearing 108 according to FIG. 3. The radial forces are discharged or transferred into the foundations by means of the support structure 102 with the particular assistance of the radial reinforcement, such as the walls 102/4.

In the case where one or more main drives 20 are removed, the radial bearings 113 and 108 are both selected to bear the imbalanced radial meshing forces.

FIG. 3 shows the dual utility of the supports 106, which may be used to increase the vertical stiffness of the support structure 102 and/or to facilitate the removal and fitting of the main drives 20.

In that case, the main drives 20 are partially supported by the support 106, and are partially supported by the ceiling plate.

As shown in FIG. 3, the main drive 20 may be removed through the following successive steps: Remove a two-part flange 107. Loosen the fastening bolts 114. Lower the main drive 20 along a direction “c” in the support 106. Remove the main drive with the support along a direction “d”. The lifting along direction “b” and the lowering along direction “c” are done by a hydraulic cylinder or leveling screws. The removal along the direction “d” and the insertion along the direction “a” of the main drives inside and outside the support structure may be done using rails.

FIG. 4 shows the solution with the permanent magnet electric motor 110 separated from the main gear unit 105 using a coupling 115. This solution is used when the torsional vibration calculation requires introducing a flexible coupling between the electric motor and the main gear unit. Fitting the electric motor separately may be advantageous when standard permanent magnet motors are used fitted vertically.

The support structure 102 may be made in a single piece, for example by welding or molding. Alternatively, the support structure 102 may be made with separate pieces that are assembled with bolts.

The other general features of the invention are as follows:

At least the main gear unit is completely suspended from the ceiling plate, in particular the main drive 20 is completely suspended from the ceiling plate.

The main gear unit is partially suspended from the ceiling.

There are no fewer than two of said main drives.

The or each motor 110 is a permanent magnet electric motor.

The or each unit extends partially above and partially below the ceiling plate 102/1.

A vertical roller mill, in particular for grinding or crushing material such as clinker or coal, comprises rollers and a drive device, the drive device being a device as described above.

1.-11. (canceled)

12. A drive device for a vertical roller mill, the drive device comprising
an output gear wheel fixed or capable of being fixed to a rotating grinding table of the vertical roller mill; and
a plurality of main drives;
a support structure having a ceiling plate;
each main drive having a motor and a main gear unit comprising a drive gear capable of meshing with the output gear wheel;
said output gear wheel being driven by each of said main drives, wherein said main drives are fitted below the ceiling plate and at least the main gear unit is partially suspended from the ceiling plate, in particular the main drive is partially suspended from the ceiling plate.

13. The drive device according to claim 12, wherein the support structure comprises a base plate and outer columns, in which the ceiling plate, the base plate and the outer columns define an inner volume of the support structure, the inner volume having a size and shape in order to completely receive all of the main drives.

14. The drive device according to claim 13, wherein the support structure comprises a central column extending between the ceiling plate and the base plate, the central column preferably having a cylindrical shape, in particular having a circular transverse section.

15. The drive device according to claim 13, wherein each outer column has an arc-shaped transverse section, each of the arc-shaped transverse sections coinciding with a pitch circle.

16. The drive device according to claim 12, further comprising at least one rib extending in the inner volume, in particular from each of the outer columns to the central column.

17. The drive device according to claim 12, wherein each main drive is a unit having a housing, as a result of which the unit is capable of being manipulated in a single piece independently of the other components of the drive device.

18. The drive device according to claim 17, wherein the housing is fastened to the ceiling plate, preferably exclusively fastened to the ceiling plate.

19. The drive device according to claim 12, wherein each main gear unit is a pseudo-planetary transmission with a stationary satellite carrier and a satellite with a double toothing or a planetary transmission.

20. The drive device according to claim 12, wherein the output gear wheel is a ring gear with an internal toothing or a ring gear with an external toothing or a gear wheel.

21. The drive device according to claim 12, wherein each drive gear is a spur gear, a helical gear or a self-aligning gear.

22. The drive device according to claim 12, wherein each of said main drives is selectively removable from the output gear wheel and removable from the support structure without moving the support structure from its base.
